(19) United States
(12) Patent Application Publication
(10) Pub. No.: US 2016/0084217 A1
(43) Pub. Date: Mar. 24, 2016

(54) Waterwheel Energy System

(71) Applicants: Robert L. Huebner, Santa Anna, TX (US); Pat McShan, Brownwood, TX (US)

(72) Inventors: Robert L. Huebner, Santa Anna, TX (US); Pat McShan, Brownwood, TX (US)

(21) Appl. No.: 14/861,244

(22) Filed: Sep. 22, 2015

Related U.S. Application Data
(60) Provisional application No. 62/054,065, filed on Sep. 23, 2014.

(51) Int. Cl. F03B 7/00

(52) U.S. Cl. CPC F03B 7/003

(57) ABSTRACT

A water driven electrical power generating system has a frame with a waterwheel carried within the frame in an upright manner having a plurality of water receiving elements for turning the waterwheel. A water discharge manifold is used to discharge water from a discharge end in alignment with the water receiving elements. A water collection reservoir disposed below the waterwheel for the collection of water which has been discharged from the manifold and received by the water receiving elements. A water pump is used to pump water from the reservoir through the water discharge manifold. The waterwheel has side plates with outwardly extending axle shafts which are used to drive an electrical generator as the wheel rotates. Each of the water receiving elements of the waterwheel consist of a series of bucket shaped troughs which are welded between the two side plates.

### CROSS REFERENCE TO RELATED APPLICATIONS

The present application claims priority from an earlier filed provisional application, Ser. No. 62/054,065, filed Sep. 23, 2014, entitled “Waterwheel Energy System, by Robert L. Huebner.

### BACKGROUND OF THE INVENTION

1. Field of the Invention:

This invention relates generally to a system and method for generating electricity and, more specifically, to a system and method for generating electricity through the use of a waterwheel located above a water reservoir, a water pump that delivers water from the reservoir to a discharge manifold which discharges water to the waterwheel at an elevated location, where the waterwheel powers a drive shaft that powers an electrical generator and is capable of being connected to a load.

2. Description of the Prior Art:

Due to the limitations of non-renewable energy sources, such as oil and coal, as well as the negative environmental effects of such energy sources, a need exists for the provision of alternative energy conversion and transfer systems. At the present time, there is increasing interest in renewable energy sources such as water based, solar, wind, wave and tidal power.

The tremendous growth in renewable energy over the past several years is well documented and the rate of growth continues to increase each year. With worldwide awareness of the negative environmental impacts of fossil fuels on our global environment, growth in the use of “green” or renewable energy appears to be constrained only by the ability to produce and deliver it at an economic price. Wind power, for example, has now entered the mainstream and has been the fastest growing segment of the energy industry over the last several years. Despite the current movement supporting renewable energy sources, many legislators and policy-makers are attempting to meet these demands through projects which relate solely to wind and solar power generation, and do not address renewable energy produced from water.

Water engines are thermodynamic engines for converting the pressure and weight of water into work and have been widely recognized as efficient source of power. Examples include water turbines for generating electricity, and waterwheels for operating belts and drive shafts to turn machinery. In the case of the waterwheel, water from, for example, a canal, reservoir or other natural waterway is typically used to fill a series of receptacles formed between a series of blades or vanes of a wheel-like structure. Imbalance resulting from the fill causes the wheel to rotate about its drive shaft, generating rotational force which may be coupled to other devices. The water is drained from the receptacles at a low point of rotation.

When driven by natural water sources, the quantity of water available to drive a turbine is often uncertain, dependent upon the changing seasons and varying climatic conditions. During a rainy season the amount and flow of water present may be too great for the turbine. Conversely, in a time of less rain fall or little water, insufficient water flow may be present for efficient operation of the turbine. While man-made reservoirs and viaducts are often constructed to provide a constant water flow, it is well recognized that such installations often require expenditures of a great deal of funds, and further may not be feasible due to the geographic and climatic conditions associated with the desired location for the turbine. They further generally represent large-scale construction, and thus are impractical for water turbines of small or moderate capacity.

One object of the present invention is to provide a water turbine which operates successfully independently of a naturally occurring flow of water from a river, canal, reservoir or the like.

Another object is to provide such a waterwheel based system which can compete economically with wind based energy generating turbine systems.

Another object of the invention is to provide such a system which can be permanently mounted at a land based location distant from a natural water source, or which can be skid mounted and moved from one location to another.

Another object of the invention is to provide a waterwheel system which can be driven by its own self-contained water source to allow a consistent output to be maintained, irrespective of variations in the flow of any nearby or distant natural water supplies.

### SUMMARY OF THE INVENTION

The foregoing objects of the invention are met through the water driven electrical power generating system of the invention. The system has a number of operable components which are mounted on a frame which serves as an enclosure for components of the system. A waterwheel is carried within the frame in an upright manner and has a plurality of water receiving elements for turning the waterwheel in response to a discharge of water against the water receiving elements.

A water discharge manifold is associated with the frame having a discharge end disposed above the waterwheel in discharge alignment with the water receiving elements. A water collection reservoir is disposed below the waterwheel and integral with the frame for the collection of water which has been discharged from the manifold and received by the water receiving elements. A water pump or pumps are also provided for pumping water from the water collection reservoir through the water discharge manifold and out the discharge end thereof onto the water receiving elements.

The waterwheel has a pair of spaced apart wheel shaped side plates each having an exterior surface and an interior surface, and wherein each of the side plates has an axle shaft welded thereon at a right angle to the exterior surface at a central location on each of the side plates, the axle shafts each being mounted in a bearing structure on the frame for rotational movement with respect to the frame. The rotational movement of the axle shafts is used to provide useful work, e.g., to drive an electrical generator for generating electrical power. In a particularly preferred version of the invention, each of the water receiving elements of the waterwheel consist of a series of bucket shaped troughs which are welded between the two side plates.

The water pumps which move water from the reservoir to the discharge manifold can be driven by an associated external power source selected from the group consisting of natural gas, solar power, propane, or the like.

Although the electrical generator which is driven by the waterwheel to generate electrical power may be mounted on the frame and directly driven by one of the axle shafts of the waterwheel, in some versions of the invention, the frame will also have mounted thereon a hydraulic pump, driven by the waterwheel axle shaft, which is used to drive a hydraulic motor, the hydraulic motor, in turn, being used to drive the electrical generator for generating electrical power. The hydraulic pump and motor may be combined in one unit. The hydraulic motor/pump and electrical generator might even sit beside the frame, or at another more spaced-apart location. In some cases, it may be desirable to have a torque multiplier for the output shaft of the waterwheel to increase the rpm output. This might comprise a suitable gear, sprocket or pulley multiplier type system, such as a gear box located between a selected one of the axle shafts of the waterwheel and the hydraulic pump/motor for creating an increased rpm output for driving the hydraulic pump/motor.

The frame can be a portable skid which allows the system to be moved from one location to another. In some cases, the frame will be located on land at a distant location from any natural water source.

Additional objects, features and advantages will be apparent from the written description which follows.

### BRIEF DESCRIPTION OF THE DRAWINGS

FIG. 1 is a simplified side view, partly schematic, of the electrical power generating system of the invention.

FIG. 2 is an isolated, exploded view of the waterwheel which is used in the electrical power generating system of the invention.

### DETAILED DESCRIPTION OF THE INVENTION

The present invention provides an improved electrical generating system that meets the foregoing objectives. The invention described herein and the various features and advantageous details thereof are explained more fully with reference to the non-limiting examples which are illustrated in the accompanying drawing and detailed in the following description. Descriptions of well-known components and processes and manufacturing techniques are omitted so as to not unnecessarily obscure the workings of the invention, The examples used herein are intended merely to facilitate an understanding of ways in which the invention herein may be practiced and to further enable those of skill in the art to practice the invention. Accordingly, the examples should not be construed as limiting the scope of the claimed invention.

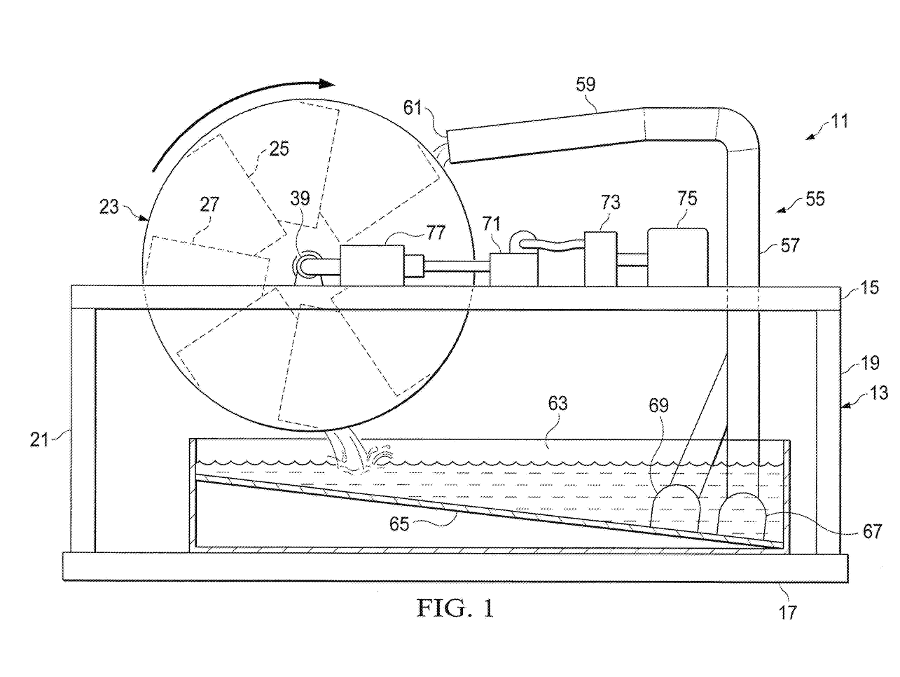

Turning first to FIG. 1, there is shown an electrical power generating system of the invention, designated generally as 11. As has briefly been described in the Summary of the Invention, the system of the invention includes a frame 13 serving as an enclosure or mounting point for the principal components of the system. The frame could assume various forms, but most simply is a rectangular structure having top and bottom elements on either side (15 and 17 shown in FIG. 1) and connecting vertical side elements (19, 21 shown in FIG. 1). The frame could be formed of steel I-beams, or the like. The frame could be a permanently mounted structure, or could be in the nature of a portable skid which would allow the system to be moved from one location to another. Because of the size and weight of the waterwheel (to be described), it might be necessary to remove the waterwheel for separate transport in some eases.

FIG. 1 shows a side view of the waterwheel 23 which is used with the system of the invention. The waterwheel 23 is carried within the frame 13 in an upright manner and has a plurality of water receiving elements (shown in FIG. 1 as 25, 27, etc., in dotted lines) for turning the waterwheel in response to a discharge of water against the water receiving elements.

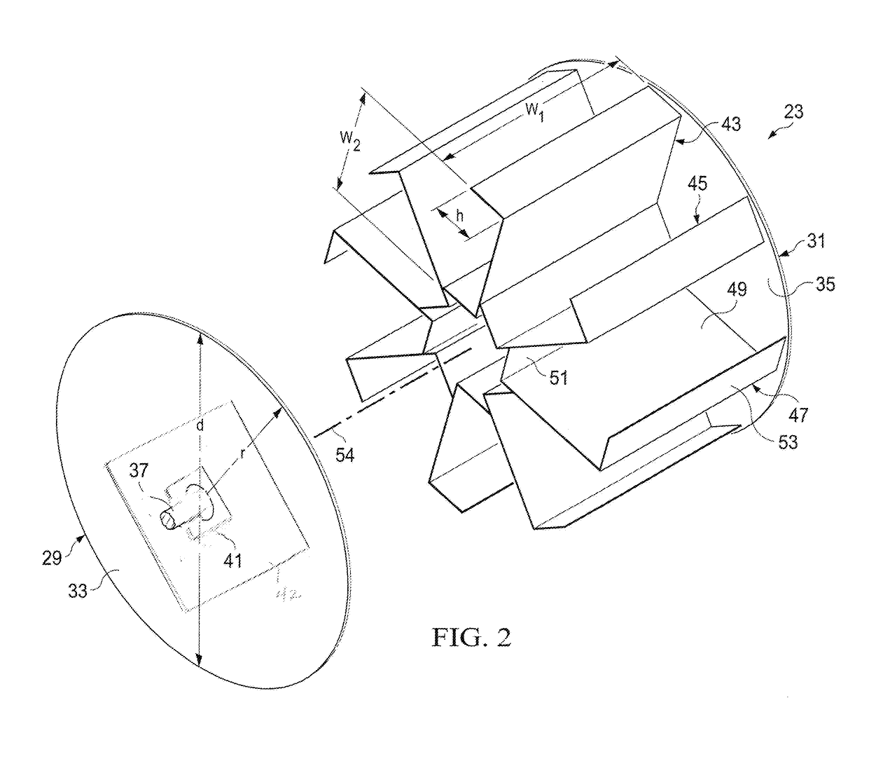

FIG. 2 shows the waterwheel 23 in exploded fashion. As will be appreciated from FIG. 2, the waterwheel 23 has a pair of spaced-apart wheel-shaped side plates 29, 31, each having an exterior surface (such as surface 33 in FIG. 2) and an interior surface (such as surface 35 in FIG. 2). The side plates 31, 33, are preferably formed of a rigid metal, such as ½ inch steel, although it is possible that a composite type material might be employed in some circumstances to reduce weight. Each of the side plates 31, 33, has a 3 inch diameter axle shaft 37 welded thereon at a generally right angle to the exterior surface 33 at a central location on each of the side plates. As best seen in FIG. 1, each of the axle shafts is rotatably mounted in a conventional bearing structure 39 located on the frame 13. This allows the waterwheel to be rotatable about a horizontal axis aligned with the axle shaft with respect to the stationary frame 13. In some cases, it may be desirable to reinforce the side plates 29, 31. In the embodiment of FIG. 2, the shaft 37 is welded to a smaller generally square plate 41 which, in turn, is welded to a larger generally square reinforcing plate 42.

As can be seen in FIG. 2, the water receiving elements of the waterwheel preferably consist of a series of bucket shaped troughs 43, 45. 47, etc., made from e.g., 3/16 inch steel, which are welded between the two side plates 31, 33. This can be accomplished by laying one of the side plates down flat and placing the upright troughs in their proper position. They can then be welded in place. The opposing side plate can then be assembled and welded to the troughs. Each isolated trough appears as a flat pan having a bottom planar wall 49 and opposing side walls 51, 53, The height of the side walls 51, 53, may be different. For example, a prototype waterwheel was constructed which was 10 feet in diameter and 6 feet in width, weighing approximately 10,000 pounds. The waterwheel had 8 troughs. For the troughs on the prototype, a 6 foot wide sheet of metal was bent in a brake to have a front edge 22 inches tall. The trough was 53 inches deep with the back wall being at a slight taper. In other words, the metal sheet was bent to form a 22 inch front lip or side wall, then coming out 53 inches and bending again, making an almost perfect rectangle. The holding capacity of the prototype waterwheel was about 5,000 gallons with 70-80% of all the troughs being full at any given time during the rotation of the waterwheel. The troughs are arranged in spiral-like fashion about the central axis 54 of the waterwheel which is co-incident with the axle shaft 37. In the version of the invention illustrated in FIG. 2, there are eight troughs welded between the two side plates 31, 33.

It is envisioned that, to produce electricity in an economical fashion, the production version of the waterwheel 23 will be quite massive in design. For example, the waterwheel itself might be 20 feet in diameter (“d” in FIG. 2), meaning a radius of 10 feet (“r” in FIG. 2). This would be twice the size of the prototype which was constructed for test purposes. The troughs shown in FIG. 2 are, for example, 10 feet wide (“w₁” in FIG. 2), having a bottom planar wall which is 6 feet across (“w₂” in FIGS. 2), and 2 feet deep (“h” in FIG. 2), providing a holding capacity of about 1200 cubic feet of water in each trough.

Returning to FIG. 1, it can be seen that the system employs a water discharge manifold 55 associated with the frame enclosure 13. In the version of the invention illustrated in FIG. 1, the manifold is a pipe-like structure having a vertical extent 57 and a gently downwardly sloping horizontally inclined extent 59 which terminates in a discharge end 61 disposed above the waterwheel in discharge alignment with the water receiving elements 25, 27, etc. The discharge end can be a plenum type structure, e.g., having a rectangular discharge opening positioned vertically over one side of the waterwheel.

A water collection reservoir 63 is disposed below the waterwheel 23 and integral with the frame 13 for the collection of water which has been discharged from the manifold 55 and received by the water receiving elements. As has been explained, imbalance resulting from filling the troughs causes the waterwheel to rotate axis of the axle shaft, with water being drained from the troughs at a low point in the rotation. In the case illustrated, the reservoir 63 is a horizontal tank having an inclined bottom wall 65. The massive size of the waterwheel and its associated troughs create a type of mechanical advantage in the system which requires only a relatively small amount of electric power to power the water pump or pumps in the system. In some cases, it might be possible to use solar power, or the power available from a natural gas well at the site of the waterwheel to power the pump or pumps used in the system.

Water collected in the reservoir 63 is re-circulated in a continuous loop through the manifold 55 and back to the waterwheel by means of one or more water pumps. The pumps 67, 69, may be identical, but may advantageously be of two different types, for example, one being electric and the other being of the centrifugal or worm screw design. The pump design will not require high pressures, but rather will need a large pumping capacity, for example 1000 gallons/minute or 60,000 gallons/hour. The pumps may be driven by an associated external power source, such as any conveniently available source of natural gas, solar power or propane. It will be necessary from time to time to make up some losses of water in the system due to evaporation and the like. This can be accomplished by having a water holding tank nearby, or using municipal or other convenient sources.

For the prototype waterwheel, the output shaft of a 50 hp electric motor was connected through a belt drive to the drive shaft of a centrifugal pump having a 1700-1800 gpm pumping capacity. The electric motor was electronically controlled with an Eaton® SVX9000 adjustable frequency drive controller (rheostat). The important factor here is the volume of water being supplied to the wheel and not the velocity of the water being pumped.

The rotational movement of the waterwheel and corresponding movement of the axle shafts 39 can be used to produce useful work, e.g., to drive an electrical generator for generating electrical power. It is possible that a conventional electrical generator might be mounted directly on the frame and be driven by the waterwheel to generate electrical power by one of the axle shafts of the waterwheel. However, in some versions of the invention, the frame 13 will also have mounted thereon a hydraulic pump 71, driven by the waterwheel axle shaft, which is used to drive a hydraulic motor 73, the hydraulic motor, in turn, being used to drive the electrical generator 75 for generating electrical power. The hydraulic motor and pump may also be incorporated in one commercially available unit. The hydraulic motor/pump and electrical generator might even sit beside the frame, or at another more distant location. in some cases, it may be desirable to have a gear/sprocket/pulley system, such as a gear box 77 located between a selected one of the axle shafts of the waterwheel and the hydraulic motor/pump for creating an increased rpm output for driving the hydraulic motor/pump.

In the prototype system, the output shaft on one side of the waterwheel goes to a 50 inch, 4 belt sheave. The 50 inch sheave goes to an 8 inch sheave mounted onto the frame. An output shaft of the 8 inch sheave carries another 50 inch, 4 belt sheave which is mounted onto the frame. The belts of the 50 inch, 4 belt sheave drive another 8 inch sheave. The output shaft of this 8 inch sheave goes to a 26 inch sheave. The belts of the 26 inch sheave drive a 5 ½ inch sheave, mounted on the frame. The output shaft of the 5 ½ sheave goes to the drive shaft of the hydraulic motor/pump. This example pulley/sheave arrangement transforms the 10-12 rpm rotational speed of the waterwheel to approximately 1800 rpm's at the hydraulic motor/pump drive shaft, The hydraulic motor/pump can be used to drive an electric generator in conventional fashion. The principal objective is to design a system of the type described which would drive a 200-300 Kwatt generator of the type currently driven by wind powered sources, and the like.

An invention has been shown with several advantages. The electrical power generating system of the invention uses water as the motive force for generating electricity, rather than using polluting fuels such as burning fossil fuels. The water in the system is re-circulated in a continuous loop so that only losses for evaporation need to be made up. It is not necessary that the system be located near a river or other body of water, because the design of the system is self sufficient. The size and capacity of the waterwheel and its associated troughs provide a type of mechanical advantage to the system which requires only a relatively small input of current to power the water pump or pumps in the system. Because of the size of the waterwheel and the nature of the pumping system, it is estimated that the system will be able to economically compete with wind based renewable energy systems, without having the associated problems of intermittent down periods that wind systems sometime suffer from. By skid mounting the system, it can be moved from one location to another.

While the invention has been shown in only one of its forms, it is not thus limited but is susceptible to various changes and modifications without departing from the spirit thereof, as described in the claims which follow.

What is claimed is:

1. A water driven electrical power generating system, the system comprising:
a frame serving as an enclosure for components of the system;
a waterwheel carried within the frame in an upright manner having a plurality of water receiving elements for turning the waterwheel in response to a discharge of water against the water receiving elements;
water discharge manifold associated with the frame enclosure having a discharge end disposed above the waterwheel in discharge alignment with the water receiving elements;
a water collection reservoir disposed below the waterwheel and integral with the frame for the collection of water which has been discharged from the manifold and received by the water receiving elements;
a water pump for pumping water from the water collection reservoir through the water discharge manifold and out the discharge end thereof onto the water receiving elements;
wherein the waterwheel has a pair of spaced apart wheel shaped side plates each having an exterior surface and an interior surface, and wherein each of the side plates has an axle shaft welded thereon at a right angle to the exterior surface at a central location on each of the side plates, the axle shafts each being mounted in a bearing structure on the frame for rotational movement with respect to the frame;
wherein the rotational movement of the axle shafts is used to drive an electrical generator for generating electrical power;
and wherein the water receiving elements of the waterwheel consist of a series of bucket shaped troughs which are welded between the two side plates.

2. The water driven electrical power generating system of claim 1, wherein the water pump is driven by an associated external power source selected from the group consisting of natural gas, solar power or propane.

3. The water driven electrical power generating system of claim 2, wherein the waterwheel side plates are on the order of 20 feet in diameter and are spaced apart on the order of 6 feet.

4. The water driven electrical power generating system of claim 3, wherein each of the bucket shaped troughs is on the order of 2 feet in depth, 10 feet in width and having a planar base area which is 6 feet wide.

5. The water driven electrical power generating system of claim 4, wherein the water pump is capable of supplying on the order of 1000 gallons/minute of water to the discharge end of the water discharge manifold.

6. A water driven electrical power generating system, the system comprising:
a frame serving as an enclosure for components of the system;
a waterwheel carried within the frame in an upright manner having a plurality of water receiving elements for turning the waterwheel in response to a discharge of water against the water receiving elements;
water discharge manifold associated with the frame enclosure having a discharge end disposed above the waterwheel in discharge alignment with the water receiving elements;
a water collection reservoir disposed below the waterwheel and integral with the frame for the collection of water which has been discharged from the manifold and received by the water receiving elements;
a water pump for pumping water from the water collection reservoir through the water discharge manifold and out the discharge end thereof onto the water receiving elements;
wherein the waterwheel has a pair of spaced apart wheel shaped side plates each having an exterior surface and an interior surface, and wherein each of the side plates has an axle shaft welded thereon at a right angle to the exterior surface at a central location on each of the side plates, the axle shafts each being mounted in a bearing structure on the frame for rotational movement with respect to the frame;
wherein the rotational movement of the axle shafts is used to drive a hydraulic motor/pump which, in turn, is used to drive an electrical generator for generating electrical power;
and wherein the water receiving elements of the waterwheel consist of a series of bucket shaped troughs which are welded between the two side plates.

7. The water driven electrical power generating system of claim 6, wherein a gear/sprocket/pulley type multiplier system is used to create an increased rpm output for driving the hydraulic motor/pump.

8. The water driven electrical power generating system of claim 7, wherein the water pump is driven by an associated external power source selected from the group consisting of natural gas, solar power or propane.

9. The water driven electrical power generating system of claim 8, wherein the frame is a portable skid which allows the system to be moved from one location to another.

10. The water driven electrical power generating system of claim 9, wherein the frame is located on land at a distant location from any natural water source.
